(19) United States
(12) Patent Application Publication
(10) Pub. No.: US 2008/0107966 A1
(43) Pub. Date: May 8, 2008

(54) Manufacturing Method of Anode Plate of Lithium Ion Battery, Anode Plate Manufactured Thereby, and Lithium Ion Battery Provided With the Anode Plate

(76) Inventors: Yunqing Lin, Guangdong Province (CN); Zewei Chen, Guangdong Province (CN); Na Zhang, Guangdong Province (CN); Can Ren, Shenzhen (CN)

Correspondence Address: JACOBSON HOLMAN PLLC, 400 SEVENTH STREET N.W., SUITE 600, WASHINGTON, DC, 20004, US

(21) Appl. No.: 11/794,230

(22) PCT Filed: Feb. 16, 2005
(86) PCT No.: PCT/CN05/00191

§ 371 Date: Jun. 27, 2007

(30) Foreign Application Priority Data
Dec. 27, 2004 (CN) 200410102452.7

(51) Int. Cl. H01M 4/00; B05D 3/02

(52) U.S. Cl. 429/209; 427/58

(57) ABSTRACT

The present invention discloses a manufacturing method of an anode plate of a lithium ion battery, comprising a water-phase slurry preparation process including a raw-material mixing step, that is, mix the raw materials of anode active material powder and particles, a conductive agent, and a conductive agent adhesive uniformly into a paste slurry, where the conductive agent adhesive is used to make the conductive agent uniformly adhere to the surface of the anode active material powder and particles. In the raw-material mixing step, an accessory adhesive is added for improving adhesion and flexibility of the plate in cooperation with the conductive adhesive. A manufacturing method of an anode plate of a lithium ion battery is disclosed. The present invention also discloses an anode plate and a lithium ion battery manufactured by this method. The present invention has the following beneficial technical effects: The process is simple, applicable for the available mass production equipments, and beneficial to industrial application and promotion; an anode plate with an acceptable surface density can be obtained by the method of the present invention, and the plate is flexible and not easily broken, thus eliminating the defect of serious “falling of materials” with the plate manufactured only using gelatin as the adhesive.

### FIELD OF THE INVENTION

The present invention relates to the materials chemistry field and the high-energy battery technology, particularly to a manufacturing method of an anode plate of a lithium ion battery, and further to the anode plate of the lithium ion battery manufactured thereby, and the lithium ion battery provided with the anode plate.

### BACKGROUND OF THE INVENTION

Lithium ion batteries are high-performance secondary batteries, which have such advantages as high working voltage, high volume and weight energy density, long service life, low self-discharge rate, no memory effect, and environment friendliness, and are widely applied in fields of mobile communication devices, notebook computers, video recorders, personal digital assistants (PDAs), digital cameras, electric tools, torpedos, missiles, etc. In recent years, the manufacturing technology of the lithium ion battery has progressed considerably, such that the capacity of, for example, a cylindrical battery, Model 18650, is increased from the original 1,200 mAh to the present 2,400 mAh. However, as for the manufacturing method of battery plates (anode plate and cathode plate), a coating process is still used. The coating method is classified into an oil-phase coating process and a water-phase coating process. In the oil-phase coating process, the anode and cathode active powders and a conductive agent are made into slurry using an organic solvent and an adhesive soluble in the organic solvent. In the water-phase coating process, the anode and cathode active powders and a conductive agent are made into slurry using water as the solvent and an adhesive soluble in water. Generally, the water-phase coating process is preferred due to low cost and no organic pollution. Currently, the water-phase coating technology has been adopted in the mass production of cathode plates, for example, with water as the solvent and sodium carboxymethyl cellulose (CMC) and styrene-butadiene rubber (SBR) latex as the adhesive. However, the oil-phase coating technology is generally still used in the mass production of anode plates.

Recently, R. Dominko et. al. proposed a manufacturing method of the anode plate via the water-phase coating process (R. Dominko et. al., Electrochemical and Solid-state Letters, 4(11) A187-A190 (2001)), which is as below: first treat the anode material particles to be applied with some polyelectrolyte such as gelatin; then add a highly conductive agent (Printen XE2, Degussa), so that each anode material particle is deposited on the surface with a layer of carbon black particles of 0.1 μm in particle size; and finally make the anode material particles, treated with gelatin and carbon black, and a current-collecting aluminum foil adhere together with additional polyelectrolyte (gelatin, cellulose, etc.) to get a plate. Due to the preferential distribution of carbon black and the adhesive, the contents of gelatin and the conductive agent can be greatly lowered in the anode plate manufactured by this method, and the content of active ingredients can be increased to about 96%, without deteriorating performance of the anode plate.

However, by adopting the method proposed by R. Dominko et. al., the anode plates manufactured with the common mass production equipments have the following disadvantages: (1) Adhesion between the anode material and the aluminum foil is poor, which results in serious falling of materials, especially in a single-side coating process; (2) the aluminum foil adhered with the anode slurry turns out to be hard with gelatin as the adhesive, less flexible than with polyvinylidene fluoride (PVDF) as the adhesive; (3) due to the low molecular weight of gelatin (the molecular weight falls within the range of 10,000-25,000), the anode plate with an acceptable surface density cannot be obtained merely with gelatin as the adhesive, that is, the anode plate with a sufficient thickness cannot be obtained.

### SUMMARY OF THE INVENTION

Accordingly, in order to overcome the disadvantages of the above manufacturing process of anode plates, the present invention is directed to a water-phase coating method of manufacturing the anode plate of the lithium ion battery, which has the desirable coating effect and is applicable for mass production equipments, as well as the anode plate manufactured via this method and the lithium ion battery provided with the anode plate.

In order to achieve the above objective, the present invention provides the following technical solution: A manufacturing method of the anode plate of the lithium ion battery, comprising a water-phase slurry preparation process including a raw-material mixing step, i.e. mix the raw materials of anode active material powder and particles, a conductive agent, a conductive agent adhesive uniformly into a paste slurry; the conductive agent adhesive is used to make the conductive agent uniformly adhere to the surface of the anode active material powder and particles; in the raw-material mixing step, an accessory adhesive is further added for improving the adhesion property between the anode material and the current collector as well as the flexibility of the plate.

In the slurry preparation process, the anode active material powder and particles, the conductive agent adhesive, the conductive agent, and the accessory adhesive to be mixed can be added according to the following orders:

First mix part of the conductive agent adhesive with the anode active material, then add the conductive agent, and then the accessory adhesive, and finally the rest of the conductive agent adhesive; or

first mix all of the conductive agent adhesive with the anode active material, then add the conductive agent, and finally the accessory adhesive; or

first mix the conductive agent adhesive with the accessory adhesive, then mix with the anode active material, and finally the conductive agent.

The conductive agent adhesive can be either gelatin or gelatin-like materials, e.g. such substitutes as algin, chitosan, and polymaltotriose, as long as the materials are applicable for the water-phase coating process and can make the conductive agent adhere to the surface of the anode active material powder and particles. The accessory adhesive can be either a water-soluble polymer compound or a mixture of several water-soluble polymer compounds.

The water-soluble polymer compound is preferably selected from the following materials: polyvinyl alcohol (PVA), polyethylene oxide (PEO), polyacrylamide, sodium polyacrylate, polyacrylate, and polyvinylpyrrolidone.

The molecular weights of the water-soluble polymer compounds are as below: polyvinyl alcohol 50,000-200,000, polyethylene oxide 50,000-500,000, sodium polyacrylate 50,000-300,000, polyacrylamide 50,000-500,000, polyacrylate 50,000-200,000, and polyvinylpyrrolidone 50,000-300,000.

The adding amount of the accessory adhesives is preferably 0.1-4.0% by weight of the anode active material.

The anode active material is selected from the lithium compounds denoted by the following chemical formulas:

1) LiₓMn_{1-y}M_{y}A₂

2) LiₓMn_{1-y}M_{y}O_{2-z}X_{z}

3) LiₓMn₂O_{4-z}X_{z}

4) LiₓMn_{2-y}M_{y}A₄

5) LiₓCo_{1-y}M_{y}A₂

7) LiₓNi_{1-y}M_{y}A₂

8) LiₓNi_{1-y}M_{y}O_{2-z}X_{z}

9) LiₓNi_{1-y}CO_{y}O_{2-z}X_{z}

10) LiₓNi_{1-y-z}Co_{y}M_{z}A_{α}

11) LiₓNi_{1-y-z}Co_{y}M_{z}O_{2-α}X_{α}

12) LiₓNi_{1-y-z}Mn_{y}M_{z}A_{α}

13) LiₓNi_{1-y-z}Mn_{y}M_{z}O_{2-α}X_{α}

where 0.95≦x≦1.1, 0≦y≦0.5, 0≦z≦0.5, and 0≦α≦2, M is selected from Al, Ni, Co, Mn, Cr, Fe, Mg, Sr, V or rare earth elements, A from O, F, S and P, and X from F, S and P.

The slurry preparation process further includes a mixed-slurry screening step with a screen of 100-500 mesh.

In the slurry preparation process, the ingredients are mixed preferably at a stirring rate of 500-20,000 rpm.

The slurry application process includes a slurry-coated plate drying step in a baking channel, with the temperature of the baking channel for a coater being 40-150° C., preferably 80-120° C.

The present invention also provides the anode plate manufactured by the above processes and the lithium ion battery provided with the anode plate.

By adopting the technical solution, the beneficial technical effects of the present invention are as follows based on the following embodiments to be illustrated in details: 1) The process is simple, applicable for the available mass production equipments, and beneficial to industrial application and promotion; 2) by the method of the present invention, an anode plate with an acceptable surface density such as 425 g/m² can be obtained, which is also flexible and not easy to be broken, thus eliminating the defect of serious “falling of materials” of the plate manufactured with gelatin as the only adhesive; 3) although the lithium ion battery provided with the anode plate manufactured by the method of the present invention has substantially the same performance as that manufactured with the common oil-phase coating process, the method of the present invention is advantageous in that it can keep the feature of less amounts of the adhesive and the conductive agent with the Dominko method, avoid the NMP (N-methyl-2-pyrrolidinone) pollution in the oil-phase coating process, and have the economic benefits from no NMP consumption.

### BRIEF DESCRIPTION OF THE DRAWINGS

FIG. 1 is a performance curve of the lithium ion battery provided with the anode plate manufactured according to the method of the present invention when being charged and discharged for 100 cycles.

FIG. 2 is a tendency chart of discharge capacity attenuation of the lithium ion battery provided with the anode plate manufactured according to the method of the present invention.

### DETAILED DESCRIPTION OF THE EMBODIMENTS

The present invention provides a manufacturing method of an anode plate of a lithium ion battery, including a slurry preparation process and a slurring application process. The slurry preparation process includes a step of uniformly mixing anode active material powder and particles, gelatin, a conductive agent, and an accessory adhesive, where the accessory adhesive is used to improve adhesion and flexibility properties of the plate in cooperation with gelatin.

The accessory adhesive can be either a water-soluble polymer compound or a mixture of several water-soluble polymer compounds, for example, polyvinyl alcohol (PVA), polyethylene oxide (PEO), polyacrylamide, sodium polyacrylate, polyacrylate, and polyvinylpyrrolidone. The molecular weight of polyvinyl alcohol is preferably 50,000-200,000, polyethylene oxide 50,000-500,000, sodium polyacrylate 50,000-300,000, polyacrylamide 50,000-500,000, polyacrylate 50,000-200,000, and polyvinylpyrrolidone 50,000-300,000. The adding amount of the accessory adhesive is preferably 0.1-4.0% by weight of the anode active material. Compared with the process of merely using gelatin for adhesion, the process of using increased amounts of the accessory adhesive can increase the viscosity, enhance the adhesion property between the anode slurry and the current collector, and improve the coating performance of the anode slurry. If the content of the accessory adhesive is too low (<0.1%), the adhesion viscosity is insufficient, which may result in poor retention of the anode slurry on the current collector, and difficulty in controlling the surface density of the anode plate; and if the content of the accessory adhesive is too high (>4.0%), the adhesion viscosity may be too high, which is also unfavorable for coating of the anode slurry, and will result in a high internal resistance of the battery provided with the anode plate. The selected polymers having a molecular weight within the preferred range can exhibit favorable accessory adhesive effects. If the molecular weight is too large, the slurry will be too thick, which is unfavorable for the coating and results in poor adhesion; and if the molecular weight is too small, the slurry will be too thin, and the retention of the slurry on the current collector (aluminum foil) will be poor, thereby the anode plate will be nonuniform in thickness, and the surface density thereof cannot meet the production requirements. When selecting water-soluble polymers, it is possible to use the water-soluble polymers having high molecular weights and those having low molecular weights together, and control the mean molecular weight around 200,000-300,000, so as to achieve better effects.

The anode active material used in the production can be selected from the lithium compounds denoted by the following chemical formulas: LiₓMn_{1-y}M_{y}A₂, LiₓMn_{1-y}M_{y}O_{2-z}X_{z}, LiₓMn₂O_{4-z}X_{z}, LiₓMn_{2-y}M_{y}A₄, LiₓCo_{1-y}M_{y}A₂, LiₓCo_{1-y}M_{y}O_{2-z}X_{z}, LiₓNi_{1-y}M_{y}A₂, LiₓNi_{1-y}M_{y}O_{2-z}X_{z}, LiₓNi_{1-y}Co_{y}O_{2-z}X_{z}, LiₓNi_{1-y-z}Co_{y}M_{z}A_{α}, LiₓNi_{1-y-z}Co_{y}M_{z}O_{2-α}X_{α}, LiₓNi_{1-y-z}Mn_{y}M_{z}A_{α}, and LiₓNi_{1-y-z}Mn_{y}M_{z}O_{2-α}X_{α}, where 0.95≦x≦1.1, 0≦y≦0.5, 0≦z≦0.5, and 0≦α≦2, M is selected from Al, Ni, Co, Mn, Cr, Fe, Mg, Sr, V, or rare earth elements, A from O, F, S and P, and X from F, S and P.

In the slurry preparation process, the anode active material powder and particles, gelatin, the conductive agent, and the accessory adhesive to be mixed can be added according to various orders, as long as the raw materials can be uniformly mixed together, with their specific features taken into consideration. For example, first mix part of the gelatin aqueous solution with the anode active material, then add the conductive agent, and then the accessory adhesive, and finally the rest of the aqueous gelatin solution; or first mix all of the gelatin aqueous solution with the anode active material, then add the conductive agent, and finally the accessory adhesive; or first mix the gelatin aqueous solution, the accessory adhesive, and the anode active material, and then add the conductive agent. During the mixing process, the pH value of the mixture can be adjusted to 7-9 with a small amount of alkali solution. This is because strong hydrogen bonds can be formed among amino acid molecules, the main component of gelatin and an amphoteric compound, under this environment to enhance the adhesion, which will make the conductive agent adhere to the surface of the anode material more uniformly during the slurry preparation process, and enhance the conductivity. An excessive high (>9) or an excessive low (<7) pH value will be unfavorable for the formation of hydrogen bonds, which will result in poor conductivity of the manufactured slurry. The alkali solution for adjusting the pH value is preferably LiOH, with which no impurities will be introduced into the solution, and thus no electrochemical properties of the battery will be affected.

In the slurry preparation process, the ingredients are mixed preferably at a stirring rate of 500-20,000 rpm. If the stirring rate is too slow, the materials cannot be mixed uniformly; if too fast, a large amount of bubbles are likely to be blended in the slurry, which is unfavorable for the coating process.

The slurry preparation process can further include a mixed-slurry screening step with a screen of 100-500 mesh, which can remove large particles in the raw materials, and avoid scratches on the plate during the coating process.

In the slurry application process, the temperature of the baking channel for the coater can be 40-150° C., preferably 80-120° C. Due to addition of the accessory adhesive, there is a high requirement for thermal stability. An excessive high temperature may cause the accessory adhesive to lose the accessory adhesion effect; and an excessive low temperature makes the moisture on the plate unlikely to be removed, thus prolonging the production cycle.

The aqueous adhesive made by the method is applicable for manufacturing the anode plate of the lithium ion battery. In this application, gelatin can make the conductive agent uniformly adhere to the surface of the anode active material, thus increasing the conductivity of anode active material. If the content of gelatin is too low (<1%), the conductivity of anode active material cannot be effectively improved; and if the content is too high (>5%), the coated anode plate will have an excessively high hardness, and the aliquation phenomenon is likely to occur. Water is used to dissolve gelatin and the water-soluble polymers. If the water is far from sufficient, gelatin and the water-soluble polymers cannot be completely dissolved; and if the water is too much, the slurry made with the adhesive will be too thin, which is unfavorable for the coating process.

Hereinafter, the implementation and effects of the present invention are illustrated in details with reference to the specific embodiments. In view that the improvement achieved by the present invention lies in the slurry preparation process for the anode plate, the detailed description of the common slurry application process, for the sake of brevity, is omitted in the embodiments.

### EMBODIMENT 1

With polyethylene oxide (PEO) as the accessory adhesive, the raw materials are formulated according to a weight ratio of LiCoO₂:the conductive agent:gelatin:PEO=100:2:2:0.5.

First dissolve 20 g gelatin and 5 g PEO (with a molecular weight of 250,000) in 460 mL and 250 mL purified water, respectively, to obtain a gelatin solution and a PEO solution, and add 0.1 M LiOH aqueous solution dropwise to the gelation solution to adjust the pH value to the range of 7 to 9. Then pour 420 mL of the formulated gelatin solution and 1,000 g of the dry anode material powder of LiCoO₂ (made by CITIC Guoan Information Industry Co., Ltd.) into a small eggbeater, stir at 4,000 rpm for 30 min, then add 20 g of the conductive agent, Super P, to the mixture in batch, and continue to stir at a high speed for 2 hr, and then add the formulated solution of accessory adhesive PEO after the slurry is substantially mixed uniformly, and stir for additional 2 hr. Finally pour in the rest 40 mL of the gelatin solution, and continue to stir for 1.5 hr, to complete the slurry formulation. The slurry can be used in the coating process after being screened with a 150-mesh screen.

### EMBODIMENT 2

With polyvinyl alcohol (PVA) as the accessory adhesive, the raw materials are formulated according to a weight ratio of LiNiO₂:the conductive agent:gelatin:PVA=100:3:2:2.

First dissolve 20 g gelatin and 20 g PVA (with a molecular weight of 150,000) in 460 mL and 250 mL purified water, respectively, to obtain a gelatin solution and a PVA solution, and add 0.1 M LiOH aqueous solution dropwise to the gelation solution to adjust the pH value to the range of 7 to 9. Then pour 420 mL of the formulated gelatin solution and 1,000 g of the dry anode material powder of LiNiO₂ into a small eggbeater, stir at 4,000 rpm for 30 min, then add 30 g of the conductive agent, Super P, to the mixture in batch, and continue to stir at a high speed for 2 hr, and then add the formulated solution of accessory adhesive PVA after the slurry is substantially mixed uniformly, and stir for additional 2 hr. Finally pour the rest 40 mL of gelatin solution, and continue to stir for 1.5 hr to complete the slurry formulation. The slurry can be used in the coating process after being screened with a 150-mesh screen.

### EMBODIMENT 3

With polyethylene oxide (PEO) as the accessory adhesive, the raw materials are formulated according to a weight ratio of LiMn₂O₄:the conductive agent:gelatin:PEO=100:3:2:1.

First dissolve 20 g gelatin and 10 g PEO (comprising 5 g of a molecular weight of 150,000 and 5 g of a molecular weight of 450,000) in 400 mL and 320 mL purified water, respectively, to obtain a gelatin solution and a PEO solution, and add 0.1 M LiOH aqueous solution dropwise to the gelation solution to adjust the pH value to the range of 7 to 9. Then pour 360 mL of the formulated gelatin solution and 1,000 g of the dry anode material powder of LiMn₂O₄ into a small eggbeater, stir at 3,000 rpm for 30 min, then add 30 g of the conductive agent, Super P, to the mixture in 4 batches, and continue to stir at a high speed for 2 hr, and then add the formulated solution of accessory adhesive PEO after the slurry is substantially mixed uniformly, and stir for additional 2 hr. Finally pour in the rest 40 mL of the gelatin solution, and continue to stir for 1.5 hr to complete the slurry formulation. The slurry can be used in the coating process after being screened with a 150-mesh screen.

### EMBODIMENT 4

With a mixture of PVA and sodium polyacrylate as the accessory adhesive, the raw materials are formulated according to a weight ratio of LiCoO₂:the conductive agent:gelatin:the mixture of PVA (with a molecular weight of 100,000) and sodium polyacrylate (with a molecular weight of 250,000) (at a weight ratio of 1:1 in the mixture)=100:2:2:3.

First dissolve 20 g gelatin in 460 mL purified water, then dissolve 30 g of the mixture of PVA (with a molecular weight of 100,000) and sodium polyacrylate (with a molecular weight of 250,000) in 250 mL purified water, and add 0.1 M LiOH aqueous solution dropwise to the gelation solution to adjust the pH value to the range of 7 to 9. Then pour 420 mL of the formulated gelatin solution and 1,000 g of the dry anode material powder of LiCoO₂ (made by CITIC Guoan Information Industry Co., Ltd.) into a small eggbeater, stir at 5,000 rpm for 30 min, and add 20 g of the conductive agent, Super P, to the mixture in batch, and continue to stir at a high speed for 2 hr, and then add the formulated solution of accessory adhesive after the slurry is substantially mixed uniformly, and stir for additional 2 hr. Finally pour in the rest 40 mL of the gelatin solution, and continue to stir for 1.5 hr to complete the slurry formulation. The slurry can be used in the coating process after being screened with a 150-mesh screen.

### EMBODIMENT 5

With polyacrylamid as the accessory adhesive, the raw materials are formulated according to a weight ratio of LiCoO₂:the conductive agent:gelatin:polyacrylamid=100:2.5:2:0.1.

First dissolve 25 g gelatin and 1 g polyacrylamid (with a mean molecular weight of 400,000) in 460 mL and 250 mL purified water, respectively, and add 0.1 M LiOH solution to the gelation solution to adjust the pH value to the range of 7 to 9. Then pour the formulated gelatin solution into a small eggbeater, start the motor to stir the solution, add 1,000 g of the anode material powder of LiCoO₂ (made by CITIC Guoan Information Industry Co., Ltd.) gradually with an average particle size of approximately 7 μm, and stir at a high speed for 30 min after the addition. And then add 25 g of the conductive agent, Super P, to the mixture in 4 batches while stirring, and stir at a high speed for additional 2 hr after the addition. Finally add 250 mL of the accessory adhesive solution, stir for additional 3 hr, till the slurry is shiny black and has desirable liquidity when it can be used for the coating process.

### EMBODIMENT 6

With a mixture of PEO, polyacrylate, and polyvinylpyrrolidone as the accessory adhesive, the raw materials are formulated according to a weight ratio of LiCoO₂:the conductive agent:gelatin:the mixture of PEO, polyacrylate and polyvinylpyrrolidone (at a weight ratio of 1:1:1)=100:2.5:2:1.

First dissolve 20 g gelatin in 460 mL purified water, and dissolve 3.33 g PEO (with a molecular weight of 450,000), 3.33 g polyacrylate (with a molecular weight of 100,000), and 3.33 g polyvinylpyrrolidone (with a molecular weight of 200,000) in 300 g purified water, and add 0.1 M of the LiOH solution to the gelation solution to adjust the pH value to the range of 7 to 9. Then pour the formulated gelatin solution into a small eggbeater, start the motor to stir the solution, add 1,000 g of the anode material powder of LiCoO₂ (made by CITIC Guoan Information Industry Co., Ltd.) gradually with an average particle size of approximately 7 μm, and stir at a high speed for 30 min after the addition. And then add 25 g of the conductive agent, Super P, to the mixture in 4 batches while stirring, and stir at a high speed for additional 2 hr after the addition. Finally add 300 mL of the accessory adhesive solution, stir for additional 3 hr, till the slurry is shiny black and has desirable liquidity when it can be used for the coating process.

### EMBODIMENT 7

With polyvinylpyrrolidone as the accessory adhesive, the raw materials are formulated according to a weight ratio of LiCoO₂:the conductive agent:gelatin:polyvinylpyrrolidone=100:3:2:4.

First dissolve 20 g gelatin and 40 g polyvinylpyrrolidone (with a mean molecular weight of 50,000) in 460 mL and 250 mL purified water, respectively, and add 0.1 M of the LiOH solution to the gelation solution to adjust the pH value to the range of 7 to 9. Then pour the formulated gelatin solution into a small eggbeater, start the motor is to stir the solution, add 1,000 g of the anode material powder of LiCoO₂ (made by CITIC Guoan Information Industry Co., Ltd.) gradually with an average particle size of approximately 7 μm, and stir at 4,500 rpm for 30 min after the addition. And then add 30 g of the conductive agent, Super P, to the mixture in 4 batches while stirring, and stir at a high speed for additional 2 hr after the addition. Finally add 250 mL of accessory adhesive solution, stir for additional 3 hr, till the slurry is shiny black and has desirable liquidity when it can be used for the coating process.

### EMBODIMENT 8

With a mixture of sodium polyacrylate, polyacrylate, and polyvinylpyrrolidone as the accessory adhesive, the raw materials are formulated according to a weight ratio of LiCoO₂:the conductive agent:gelatin:the mixture of sodium polyacrylate, polyacrylate, and polyvinylpyrrolidone (at a weight ratio of 1:1:1)=100:3:3:0.5.

First dissolve 30 g gelatin in 460 mL purified water, and dissolve 1.67 g sodium polyacrylate (with a molecular weight of 60,000), 1.67 g polyacrylate (with a molecular weight of 80,000), and 1.67 g polyvinylpyrrolidone (with a molecular weight of 150,000) in 250 ml purified water successively, and add 0.1 M of the LiOH solution to the gelation solution to adjust the pH value to the range of 7 to 9. Then pour the formulated gelatin solution into a small eggbeater, start the motor to stir the solution, and add 250 mL of the accessory adhesive solution and mix uniformly. And then add 1,000 g of the anode material powder of LiCoO₂ (made by CITIC Guoan Information Industry Co., Ltd.) gradually with an average particle size of approximately 7 μm, and stir at 4,500 rpm for 2 hr after the addition. And then add 30 g of the conductive agent, Super P, to the mixture in 4 batches while stirring, stir at a high speed for additional 3 hr after then addition, till the slurry is shiny black and has desirable liquidity when it can be used for the coating process.

### EMBODIMENT 9

With a mixture of PVA and polyacrylate as the accessory adhesive, the raw materials are formulated according to a weight ratio of LiCoO₂:the conductive agent gelatin:the mixture of PVA and polyacrylate (at a weight ratio of 2:3)=100:2.5:2:0.5.

First dissolve 25 g gelatin in 460 mL purified water, and dissolve 2 g PVA (with a molecular weight of 150,000) and 3 g polyacrylate (with a molecular weight of 150,000) in 250 ml purified water successively, and add 0.1 M of the LiOH solution to the gelation solution to adjust the pH value to the range of 7 to 9. Then pour the formulated gelatin solution into a small eggbeater, start the motor to stir the solution, then add 1,000 g of the anode material powder of LiCoO₂ (made by CITIC Guoan Information Industry Co., Ltd.) gradually with an average particle size of approximately 7 μm, and stir at 3,500 rpm for 30 min after the addition. And then add 20 g of the conductive agent, Super P, to the mixture in 4 batches while stirring, and stir at a high speed for additional 2 hr after the addition. Finally add 250 mL of the accessory adhesive solution, stir for additional 3 hr, till the slurry is shiny black and has desirable liquidity when it can be used for the coating process.

### EMBODIMENT 10

With sodium polyacrylate as the accessory adhesive, the raw materials are formulated at a weight ratio of LiCoO₂:the conductive agent:gelatin:sodium polyacrylate=100:2.5:2:1.0.

First dissolve 20 g gelatin and 10 g sodium polyacrylate (with a molecular weight of 100,000) in 460 mL and 250 mL purified water, respectively, to obtain a gelatin solution and a sodium polyacrylate solution, and add 0.1 M of the LiOH aqueous solution to the gelation solution to adjust the pH value to the range of 7 to 9. Then pour 460 mL of the formulated gelatin aqueous solution into a small eggbeater, add 1,000 g of the anode material powder of LiCoO₂ (made by CITIC Guoan Information Industry Co., Ltd.) gradually with an average particle size of approximately 7 μm while stirring, and stir at a high speed for 30 min after the addition. Then add 25 g of the conductive agent, Super P, to the mixture in batch, and stir at a high speed for additional 2 hr. Finally add 250 mL of the accessory adhesive of the sodium polyacrylate solution, and stir for additional 3 hr, till the slurry is shiny black and has desirable liquidity when it can be used for the coating process.

Hereinafter, the performances of the lithium ion battery provided with the anode plate manufactured by the method of the present invention are illustrated.

(1) Manufacture of Anode Plate

A coater of 4 m in length is used to coat the water-based slurry formulated in the above embodiments. The temperatures of the front, middle, and rear baking channels for the coater were set at 90° C., 95° C. and 100° C., respectively. The aluminum foil of the current collector is 20 μm in thickness and 280 mm in width. The single-side coating thickness of the aluminum foil is 130 μm, and the double-side coating thickness of the aluminum foil is controlled at 250 μm. All of the slurries of Embodiments 1-10 of the present invention can be applied successfully under the above conditions. For example, an anode plate with a surface density of 425 g/m² can be obtained by using the slurry of Embodiment 1, and the plate is flexible and not easily broken. On the contrary, if the method of the present invention is not followed merely with gelatin as the adhesive, the phenomenon of serious “falling of materials” will occur with the plate when the slurry is applied to a single side by the coater, and the plate is grizzled; when it is applied to double sides, the situation is better, the plate is relatively hard, while the aliquation phenomenon easily occurs when the plate is folded. If sodium carboxymethyl cellulose is used as a secondary accessory adhesive, the adhesion property can be improved, however, the plate is harder than that made merely with gelatin as the adhesive, the aliquation phenomenon easily occurs when the plate is folded, and therefore the plate is not desirable, either.

(2) Manufacture of Cathode Plate

The cathode plate is manufactured according to the production process of the cathode plate for a liquid-electrolyte lithium ion battery. The graphite from Xingcheng, Changsha is selected as the cathode material, and the water-based adhesives, sodium carboxymethyl cellulose (CMC) and SBR latex, are selected as the adhesive. During the slurry preparation process, first dissolve 2 parts by weight of CMC in 100 parts by weight of water, then add 5 parts by weight of SBR latex while stirring, add 92 parts by weight of graphic powder, and a cathode slurry can be obtained after continuous strong stirring for 4 hr. Then apply the cathode slurry to the double sides of the aluminum foil of 12 μm in thickness with a small coater of 4 m in length, and obtain a cathode plate after drying.

Cut the anode plate, the cathode plate, and a diaphram paper (Celgard 2300) according to the size required by the Model “053048S” battery. Then perform in sequence such processes commonly used in the manufacture of batteries as spot welding the taps, drying the plate, rolling, assembling with a case, laser welding the cover, drying, and injecting the electrolyte, to produce a battery, which can then go through the precharging process and formation process.

(4) Battery Test

Inject 2.4 g of the organic electrolyte into the dried semifinished battery, and leave it for 2 hr. Then test according to a certain charge-discharge system, which is as below: In Step 1, charge with a constant current of 0.05 CmA for 60 min; in Step 2, charge with a constant current of 0.1 CmA for 50 min; in Step 3, charge with a constant current of 0.5 CmA till the voltage reaches 4.2 V; in Step 4, charge with a constant voltage of 4.2 V till the current reaches 30 mA, and leave it for 5 min; in Step 5, discharge at a constant current of 0.5 CmA till the voltage reaches 3.0 V, and leave it for 5 min; in Step 6, charge with a constant current of 1 CmA at a constant voltage; in Step 7, discharge at a current of 1 CmA till the voltage reaches 2.75 V, and thereby the steps of precharg and formation of the battery are finished. Finally seal the battery to produce the finished steel-cased battery of Model “0530488”.

Then perform a cycle test on the battery that has been precharged and formed according to a system, which is as below: In Step 1, charge with a constant current of 1 CmA till the voltage reaches 4.2 V; in Step 2, charge with a constant voltage of 4.2 V till the current reaches 30 mA, and leave it for 5 min; in Step 3, discharge at a constant current of 1 CmA till the voltage reaches 2.75 V; and cycle according to such a system for times as required.

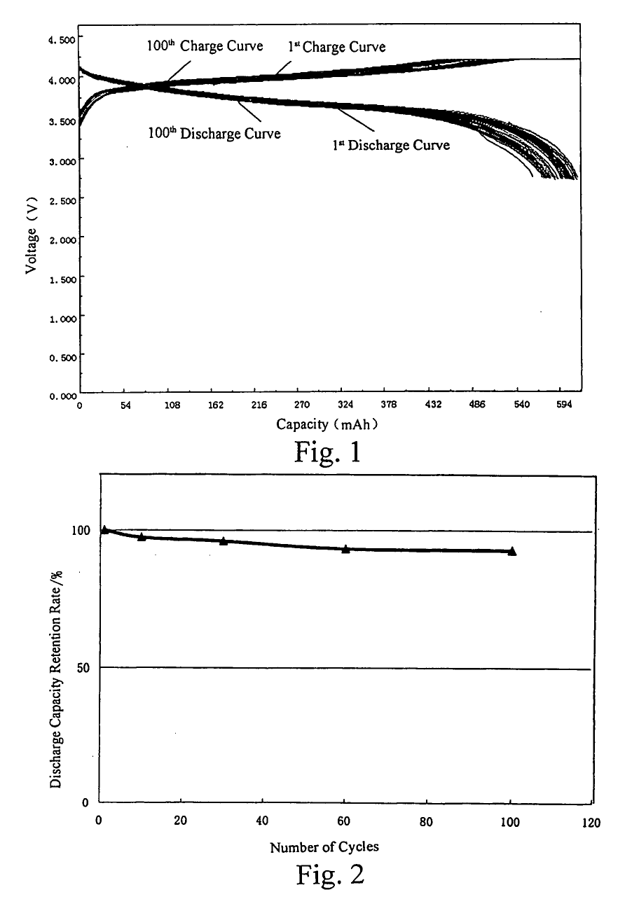

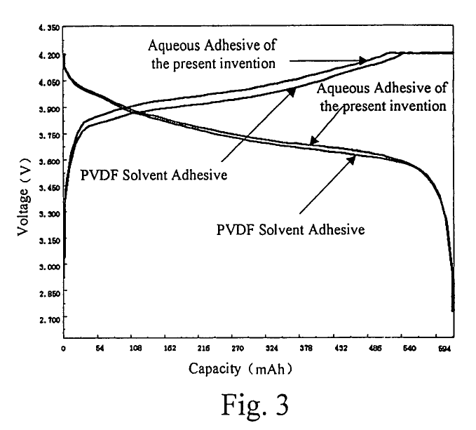

The test result shows that, the battery provided with the anode plate manufactured by the method of the present invention has substantially the same performance as that manufactured with the common oil-phase coating process. After performing the charge-discharge cycle test for 100 times, the discharge capacity retention rate of the battery provided with the anode plate manufactured by the method of the present invention can reach up to 92%, which satisfies the battery quality standards (see FIGS. 1 and 2). The method of the present invention is advantageous in that it can keep the feature of less amounts of the adhesive and the conductive agent in the Dominko method, avoid NMP pollution in the oil-phase coating process, and have the economic benefits from no NMP consumption.

1. A manufacturing method of an anode plate of a lithium ion battery, comprising a water-phase slurry preparation process including a raw-material mixing step of mixing the raw materials of anode active material powder and particles, a conductive agent, a conductive agent adhesive, and an accessory adhesive uniformly into a paste slurry, where the conductive agent adhesive is used to make the conductive agent uniformly adhere to the surface of the anode active material powder and particles; and the accessory adhesive is used for improving the adhesion property between the anode material and a current collector as well as the flexibility of the plate; wherein in the slurry preparation process, the anode active material powder and particles, the conductive agent adhesive, the conductive agent, and the accessory adhesive to be mixed can be added according to one of the following orders of A, B and C;
A. first mix part of the conductive agent adhesive with the anode active material, then add the conductive agent, and then the accessory adhesive, and finally the rest of the conductive agent adhesive;
B. first mix all of the conductive agent adhesive with the anode active material. then add the conductive agent, and finally the accessory adhesive; and
C. first mix the conductive agent adhesive with the accessory adhesive, then mix with the anode active material, and finally add the conductive agent.

2. (canceled)

3. The manufacturing method of the anode plate of the lithium ion battery according to claim 1, wherein the conductive agent adhesive is gelatin, and the accessory adhesive is a water-soluble polymer compound or a mixture of several water-soluble polymer compounds.

4. The manufacturing method of the anode plate of the lithium ion battery according to claim 3, wherein the water-soluble polymer compound is selected from the following materials: polyvinyl alcohol, polyethylene oxide, polyacrylamide, sodium polyacrylate, polyacrylate, and polyvinylpyrrolidone.

5. The manufacturing method of the anode plate of the lithium ion battery according to claim 4, wherein the molecular weights of the water-soluble polymer compounds are as below: polyvinyl alcohol 50,000-200,000, polyethylene oxide 50,000-500,000, sodium polyacrylate 50,000-300,000, polyacrylamide 50,000-500,000, polyacrylate 50,000-200,000, and polyvinylpyrrolidone 50,000-300,000.

6. The manufacturing method of the anode plate of the lithium ion battery according to claim 1, wherein the adding amount of the accessory adhesive is 0.1-4.0% by weight of the anode active material.

7. The manufacturing method of the anode plate of the lithium ion battery according to claim 1, wherein the anode active material is selected from the lithium compounds denoted by the following chemical formulas:
1) LiₓMn_{1-y}M_{y}A₂
2) LiₓMn_{1-y}M_{y}O_{2-z}X_{z}
3) LiₓMn₂O_{4-z}X_{z}
4) LiₓMn_{2-y}M_{y}A₄
5) LiₓCo_{1-y}M_{y}A₂
6) LiₓCo_{1-y}M_{y}O_{2-z}X_{z}
7) LiₓNi_{1-y}M_{y}A₂
8) LiₓNi_{1-y}M_{y}O_{2-z}X_{z}
9) LiₓNi_{1-y}Co_{y}O_{2-z}X_{z}
10) LiₓNi_{1-y-z}Co_{y}M_{z}A_{α}
11) LiₓNi_{1-y-z}Co_{y}M_{z}O_{2-α}X_{α}
12) LiₓNi_{1-y-z}Mn_{y}M_{z}A_{α}
13) LiₓNi_{1-y-z}Mn_{y}M_{z}O_{2-α}X_{α}
where 0.95≦x≦1.1, 0≦y≦0.5, 0≦z≦0.5, and 0≦α≦2, M is selected from Al, Ni, Co, Mn, Cr, Fe, Mg, Sr, V or rare earth elements, A from O, F, S and P, and X from F, S and P.

8. The manufacturing method of the anode plate of the lithium ion battery according to claim 1, wherein the mixing process is performed at a stirring rate of 500-20,000 rpm.

9. The manufacturing method of the anode plate of the lithium ion battery according to claim 1, wherein the slurry application process includes a slurry-coated plate drying step in a baking channel, and the temperature of the baking channel for a coater is 40-150° C.

10. The manufacturing method of the anode plate of the lithium ion battery according to claim 9, wherein the temperature of the baking channel for the coater is 80-120° C. during the slurry application process.

11. The anode plate of the lithium ion battery, wherein the anode plate is manufactured according to claim 1.

12. The lithium ion battery, wherein it is provided with the anode plate according to claim 11.
